(19) United States
(12) Patent Application Publication
(10) Pub. No.: US 2024/0045742 A1
(43) Pub. Date: Feb. 8, 2024

(54) SUBGRAPH GENERATION VIA TAGGING FOR A FEDERATED APPLICATION PROGRAMMING INTERFACE SERVICE

(71) Applicant: Salesforce, inc., San Francisco, CA (US)

(72) Inventors: Gaurav Sagar, Bellevue, WS (US); Antonio Garrote, San Francisco, CA (US); Patricio Barletta, Brentwood, CA (US); Javier Isoldi, Olivos, AR (US); Ignacio Bottero, Tandil, AR (US); Ximena Zuberbuhler, San Isidro (AR)

(21) Appl. No.: 17/817,471

(22) Filed: Aug. 4, 2022

(51) Int. Cl. G06F 9/54

(52) U.S. Cl. CPC G06F 9/543

(57) ABSTRACT

A computing system may support a federation management service that receives an input indicating a plurality of data sources comprising one or more tags corresponding to one or more elements of the plurality of data sources. The federation management service may generate a federated application programming interface (API) using the data sources, and the federated API may include elements of the data sources. The federation management service may receive a second user input selecting a set of tags for exclusion or inclusion of elements in a subgraph of the federated API. The federation management service may generate the subgraph that includes a subset of the one or more elements of the plurality of data sources.

### FIELD OF TECHNOLOGY

The present disclosure relates generally to database systems and data processing, and more specifically to subgraph generation via tagging for a federated application programming interface service.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant data processing system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Clients or applications may interact with computing services via application programming interfaces (APIs). In some examples, an application may access different types of services (e.g., database service, web-service) using different APIs. However, configuration of an application to access different APIs may require significant overhead and may result in application inefficiencies. More particularly, a developer may need to configure an application to access multiple APIs with different authentication settings, among other settings. Additionally, as an application may need to ping different APIs to perform a service, the application may have built-in latencies due to an operation depending on responses from multiple APIs, which may have different response times.

### BRIEF DESCRIPTION OF THE DRAWINGS

FIG. 1 illustrates an example of a data processing system that supports subgraph generation via tagging for a federated application programming interface service in accordance with aspects of the present disclosure.

FIG. 2 illustrates an example of a computing environment that supports subgraph generation via tagging for a federated application programming interface service in accordance with aspects of the present disclosure.

FIG. 3 through 4 illustrate examples of a federation management service that supports subgraph generation via tagging for a federated application programming interface service in accordance with aspects of the present disclosure.

FIG. 5 illustrates an example of a process flow that supports subgraph generation via tagging for a federated application programming interface service in accordance with aspects of the present disclosure.

FIG. 6 shows a block diagram of an apparatus that supports subgraph generation via tagging for a federated application programming interface service in accordance with aspects of the present disclosure.

FIG. 7 shows a block diagram of an API manager that supports subgraph generation via tagging for a federated application programming interface service in accordance with aspects of the present disclosure.

FIG. 8 shows a diagram of a system including a device that supports subgraph generation via tagging for a federated application programming interface service in accordance with aspects of the present disclosure.

FIGS. 9 through 11 show flowcharts illustrating methods that support subgraph generation via tagging for a federated application programming interface service in accordance with aspects of the present disclosure.

### DETAILED DESCRIPTION

Clients or applications may interact with computing services via application programming interfaces (APIs). In some examples, an application may access different types of services (e.g., database service, web-service) using different APIs. However, configuration of an application to access different APIs may require significant overhead and may result in application inefficiencies. More particularly, a developer may need to configure an application to access multiple APIs with different authentication settings, among other settings. Additionally, as an application may need to ping different APIs to perform a service, the application may have built-in latencies due to an operation depending on a response from multiple APIs, which may have different response times.

Users of these various APIs may federate these APIs into a single federated API such as to simplify application configuration. An API federation service may generate a federated API that aggregates multiple data sources (e.g., APIs, databases, etc.), such that downstream consumers of the federated API can make a single query to retrieve data from the multiple data sources. However, the federated API may expose all of the data from the multiple underlying data sources, which may cause data privacy, confidentiality, and data governance and access control issues. Furthermore, exposing all of the data and elements from the multiple underlying data sources may also limit the ability to create unique backend for front end (BFF) APIs that are specific to a particular front end application.

Techniques described herein support a user (e.g., an API architect or administrative user) annotating the specifications of the source APIs (or other data sources) with tags (e.g., confidential, experimental, production, etc.). When the API federation service generates the federated graph (e.g., a federated API), the tags from the source APIs are incorporated into the federated graph. The user may then declaratively create a subgraph (e.g., a filtered view of the parent federated graph or a sub-API of the federated API) by selecting which tags are “allowed” and which ones are “denied.” The API federation service may then generate the subgraph (e.g., “View”) by including only elements (e.g., methods, objects, fields) that are associated with tags that are indicated as “allowed.” Additional techniques described herein support versioning techniques for subgraph implementations, subgraph deployment configurations, among other techniques.

Aspects of the disclosure are initially described in the context of an environment supporting an on-demand database service. Aspects of the disclosure are further described with respect to a computing environment illustrating federated API generation and subgraph generation, a federation management service, and a process flow. Aspects of the disclosure are further illustrated by and described with reference to apparatus diagrams, system diagrams, and flowcharts that relate to subgraph generation via tagging for a federated application programming interface service.

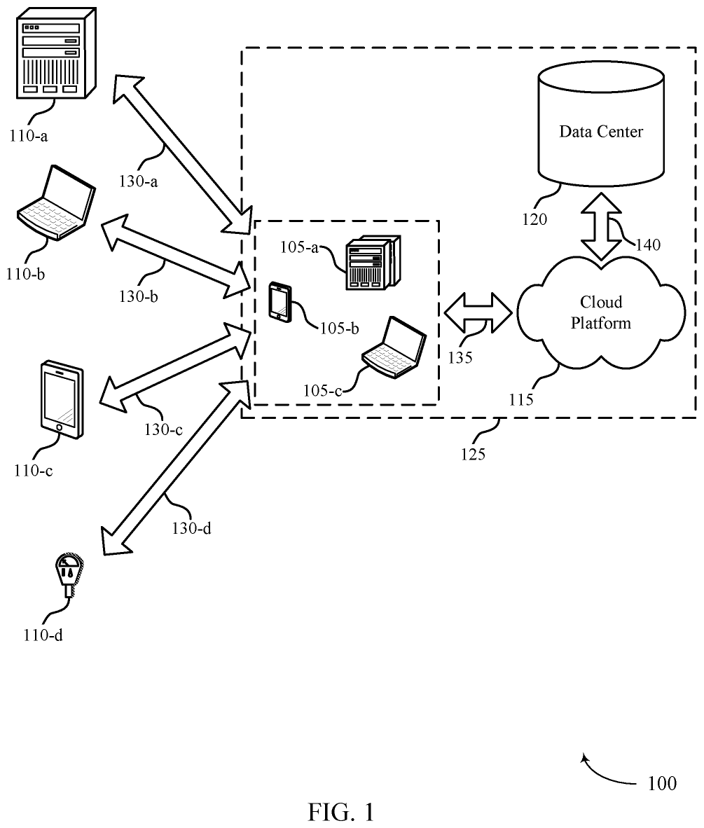

FIG. 1 illustrates an example of a system 100 for cloud computing that supports subgraph generation via tagging for a federated application programming interface service in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some examples, a cloud platform may support various APIs that may be accessed by client devices and/or systems (e.g., applications). In some examples, an application may be configured to access multiple different APIs to support various services. Configuration of an application to access the various APIs may involve significant complexities. A federated API may be used to combine API elements for reduced configuration complexities. However, a federated APIs (or hosts of the federated API) may not be configured to handle varying loads for requests. Finally, some experimental elements or confidential data of the underlying APIs may be exposed by the federated API.

As described herein, the cloud platform 115 may support a federation service that generates a federated API based on underlying data sources that are selected for inclusion in the federated API. A subgraph or portion of the federated API may be configured using the federation management service. The subgraph may be generated by selection of tags that are included in the federated API for inclusion into or exclusion from the subgraph. Thus, a subset of elements of the federated API may be included in the subgraph, which may limit or prevent access to elements that are confidential or experimental. Additionally, the subgraph may be generated and deployed based on user inputs, and in some examples, a quantity of worker nodes may be deployed for handling requests to the subgraph.

For example, a federated API for accessing order data may combine elements of multiple APIs. However, some of the elements of the API are tagged as being experimental or as corresponding to particular end user device operating systems. Thus, an administrator may generate a subgraph for use by such operating systems. When configuring the subgraph, the administrator may select the tag corresponding to the operating system for inclusion in the subgraph and may select the tag corresponding to experimental elements for exclusion from the subgraph. As such, the generated subgraph may be specifically customized for the operating system and may inhibit or limit access to experimental elements by the client devices.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

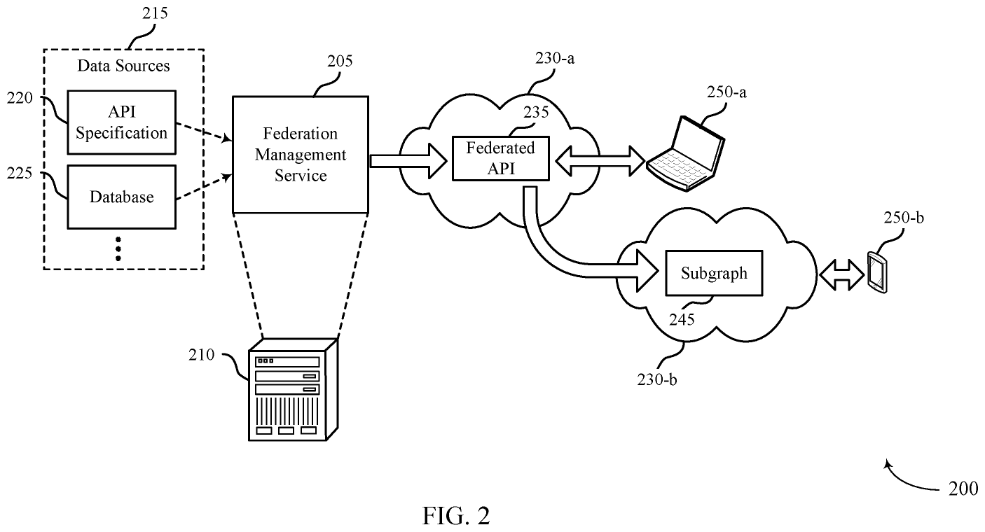

FIG. 2 illustrates an example of a computing environment 200 that supports subgraph generation via tagging for a federated application programming interface service in accordance with aspects of the present disclosure. The computing environment 200 includes a server 210, hosts 230, and client devices 250. The server 210 may be an example of aspects of cloud platform 115 of FIG. 1 and/or subsystem 125 of FIG. 1. The server 210 may represent various physical and/or logical computing systems that support a federation management service 205 that may be used by clients or tenants (e.g., cloud client 105 of FIG. 1) in support of applications that are accessible via computing devices, such as client devices 250.

Some applications (e.g., client applications executing on client devices 250, web services, etc.) may retrieve data from multiple data sources, such as data sources 215. For example, an application (or service supported by an application) may provide a status of an online purchase order, and the application may retrieve data related to shipping information from a first data source, data related to order status information from a second data source, and data related to the item being purchased from a third data source. The application may interface with these data sources using respective APIs. The data sources may include RESTful APIs, Async APIs, gRPC APIs, databases or the like. Conventional techniques for retrieving data or accessing services may require configuration of multiple APIs at the application and configuration of the application to process the data received from the multiple APIs (e.g., by merging or linking fields via hardcoded relationships).

The federation management service 205 described herein may support the creation of an aggregated or federated API 235 based on multiple data sources 215. In such examples, a user (e.g., an API architect or administrator) may declaratively link elements from multiple APIs using a user interface. The federation management service 205 may generate a new API having a unified schema that incorporates the linked elements across the multiple data sources 215. In some examples, the federated API may be referred to as a datagraph.

The federation management service 205 may support a user interface (UI) that allows a user to select multiple data sources 215 that are to be included in the federated API 235. The user may also select various deployment configurations, such as a host environment (e.g., a host 230-a, which may be an example of a cloud environment), endpoint details, authentication details, and the like. After selection of configuration parameters, the federation management service 205 may ingest or process the data sources 215, such as APIs and databases based on API specification 220 and/or a schema of a database 225, to generate the federated API 235. The federated API 235 may be deployed at the host environment (e.g., host 230-a) based on the user selected parameters. In some examples, the federated API 235 is deployed in a cloud environment (e.g., host 230-a). Additionally, or alternatively, the federated API 235 may be deployed at a local host (e.g., at a host associated with or supported by the server 210) or a host associated with the tenant or cloud client.

An application or client (e.g., an application or client executing on client devices 250) may be configured to access an endpoint of the federated API 235 to access data and/or services supported by the underlying data sources 215. As such, rather than accessing the data/services from multiple data source endpoints for each for the data sources 215, the application is configured to access the data/services using the endpoint(s) for the federated API 235, which may support improved computing efficiency (e.g., at the application and the hosts) and reduced complexity.

However, in some examples, a federated API may expose some or all of the data from the underlying data sources 215. This exposure may cause some parts of the data sources 215, such as confidential information or experimental elements, to be exposed to end users (e.g., client devices 250-a or 250-b). Further, in some cases, an API architect may not be able to specify which parts of the federated API 235 are exposed to a consumer or application, which may be an example of a data governance issue and an access control issue. Moreover, customers who want to create a unique backend that are specific to the front end applications, the architects need to account for data types and fields they should not use in the front end applications. Finally, the types and fields of the federated API 235 may not be queried equally, and the API architect may not be able to create separate endpoints with high compute power for types/fields that are queried relatively frequently.

Techniques described herein support the generation of subgraphs (e.g., subgraph 245) based on a federated API (e.g., federated API 235). The subgraph 245 may include a subset of elements that are included in the federated API 235, which may support reduced or limited exposure of confidential or experimental elements of the data sources 215, customized access based on application needs, and targeted scaling, among other benefits. A subgraph 245 may be referred to as a view, datagraph view, graph view, sub-API, or the like.

To support subgraph 245 generation, data sources 215 may be configured with tags that correspond to elements of the data sources 215. The tags may indicate whether an element is experimental, confidential, production, whether an element is configured for a particular application or end user environment/operating system, or the like. For example, various operations or fields may be tagged with an indication that the operations or fields are to be used for a specific smartphone operating system. When the data sources 215 including the tags are used to generate the federated API 235, the federated API 235 (e.g., the API specification) includes the tags.

During configuration of the subgraph 245, the federation management service 205 may support a UI that displays the tags that are included in the data sources 215 and the resulting federated API 235. More particularly, during configuration of the subgraph 245 based on the federated API 235, the UI of the federation management service 205 may display the tags for selection by a user. The user may select one or more tags for exclusion from and/or inclusion of corresponding elements into the subgraph 245. For example, the user may select tags for a particular environment or application that is to access the subgraph 245. Additionally, or alternatively, the user may select tags that are to be excluded, such as tags that indicate an element of a data source 215 is experimental or confidential. When the federation management service 205 generates the subgraph 245 based on the user selection, the federation management service 205 may include elements corresponding to tags that are selected for inclusion in the subgraph 245 such that the elements are exposed to a user/application that accesses the subgraph 245.

The federation management service 205 may also support deployment configurations for the subgraph 245, such a host or host environment for the subgraph 245 (e.g., host 230-b), an amount of workers or replicas for the subgraph 245, among other configurations. The deployment configurations may not impact the implementation of the parent application (e.g., the federated API 235).

Additionally, the lifecycle and versioning of the subgraph 245 may be automatically managed by the federation management service 205. For example, one of the data sources 215 is updated, and the federation management service 205 automatically creates a new version of the federated API 235 and the subgraph 245. Updates to the data sources 215 may include addition, deletion, or modification of a tag, updating the specification, etc. In some cases, a user may modify tag selections, and a new version of the subgraph is automatically generated (without updating the federated API). The new version of the subgraph may be deployed to the host 230-b.

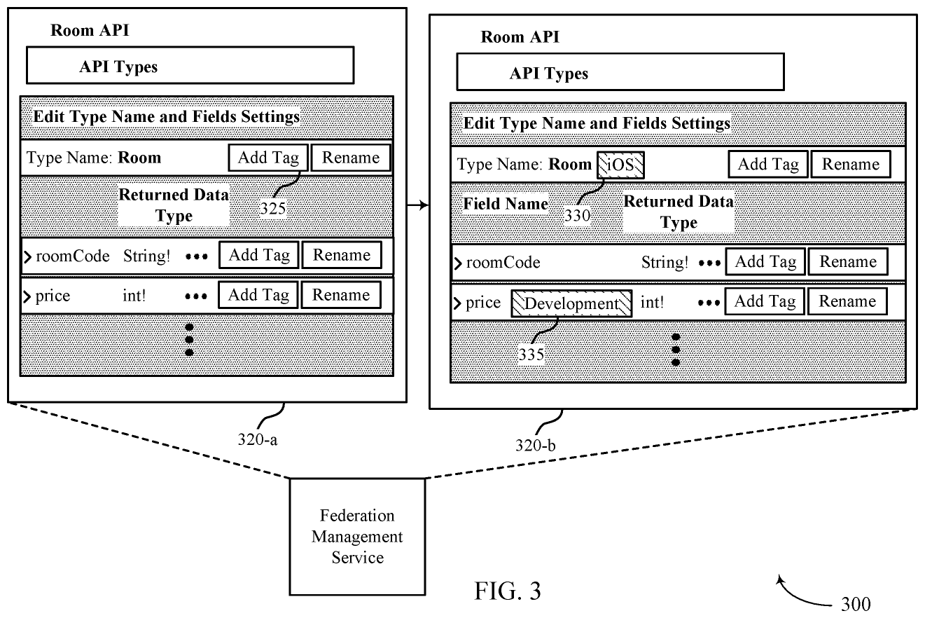

FIG. 3 illustrates an example of a federation management service 300 that supports subgraph generation via tagging for a federated application programming interface service in accordance with aspects of the present disclosure. The federation management service 300 may be an example of the federation management service as described with respect to FIG. 2. The federation management service may support various data source federation techniques as described herein, such as federated API generation, subgraph generation, subgraph deployment, subgraph versioning, etc.

As illustrated in FIG. 3, the federation management service 300 may support a user interface 320 that is used to add tags to elements of the data sources of a federated API (e.g., federated API 235 of FIG. 2). For example, prior to the user interfaces illustrated in FIG. 3, a user may access the federation management service 300 to select data sources that are used to generate the federated API. The federation management service 300 may be preconfigured with access to a set of APIs (e.g., data sources 215 of FIG. 2) associated with a tenant or organization (e.g., a cloud client 105 of FIG. 1) or the user may enter various API details (e.g., API type, endpoint) in order to support the federation management service 300 accessing the API. After selecting the data sources, the user may provide authentication details and uniform resource locator (URL) endpoints to access the running instance of the API. The user may edit the translated schema, such as by renaming fields, types, and adding tags, as described below.

By allowing the user to add tags to the elements of data sources (as illustrated at user interface 320), users are able to create views or subgraphs on top of a federated API that is generated based on underlying data sources without tags or without tags on elements that are to be used by a federation architect.

In FIG. 3, the API federation management service 300 is accessing a REST API named “Room API.” The Room API may have the following API specification (in RESTful API Modeling Language (RAML) format):

```
#%RAML 1.0
title: Rooms API
version: v1
types:
Room:
  properties:
  Title: string
  RoomCode: string
  Price: integer
  RoomView: string
/rooms/{RoomCode}:
get:
  responses:
  200:
  body:
  application/json:
    type: Room
```

The above REST API specification of a data source is input into the federation management service 300. The API specification does not have any tags for any of the elements (e.g., for the Room type, or fields in the type such as Title, RoomCode, Price, or RoomView). The Room API takes a RoomCode as a uniform resource identifier (URI) parameter hypertext transfer protocol (HTTP) GET method and provides a response with a RoomType. The RoomType includes four fields (properties), namely, Title, RoomCode, Price, and RoomView.

The federation management service 300 translates the REST API specification elements to GraphQL elements (or another type of federated API element format) when adding the data source (Room API) to the federated API. As illustrated, the user interface 320-a of the federation management service 300 shows that the REST API specification did not include any tags. Using the user interface 320-a, the user (e.g., API architect) can use user interface components (e.g., a user interface component 325) to add tags to elements. After activating the user interface component, an input field is provided where a user can enter the tag name.

Once the user has provided the tags for the elements that are to be registered for the data source, the tags may show up in the user interface, as shown in user interface 320-b. For example, user interface 320-b illustrates that a user has added a tag 330 (“iOS”) to the Room type and a tag 335 (“Development”) to the price field. As described in further detail herein (e.g., in FIG. 3), these tags may be subsequently used to allow a user to allow or deny tags for a subgraph.

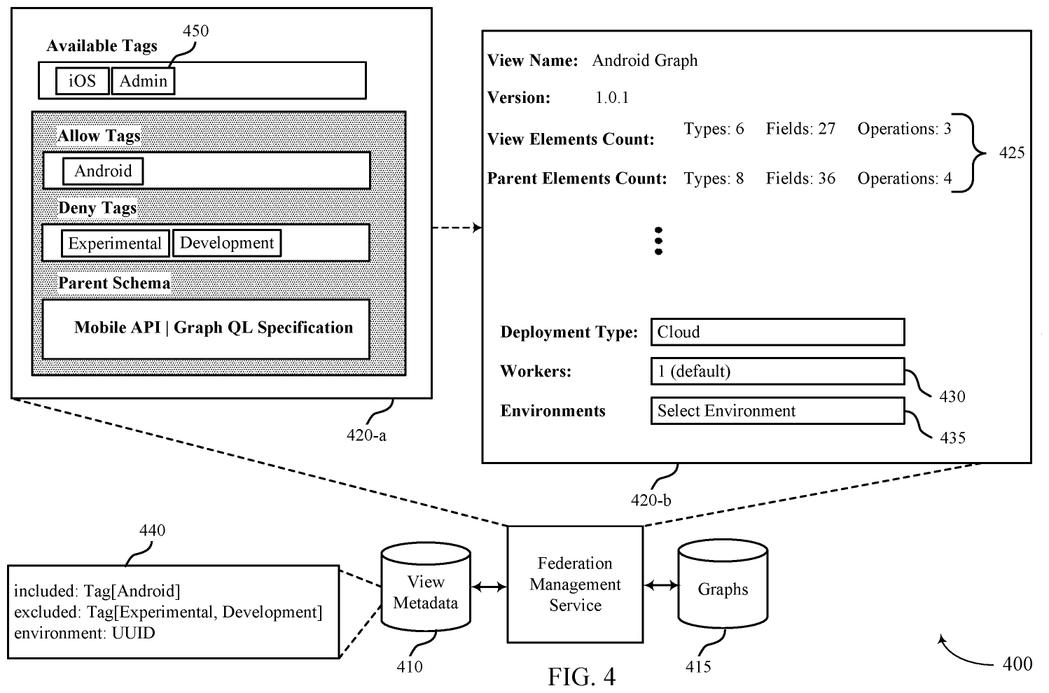

FIG. 4 illustrates an example of a federation management service 400 that supports subgraph generation via tagging for a federated application programming interface service in accordance with aspects of the present disclosure. The federation management service 400 may be an example of the federation management service as described with respect to FIG. 2 and FIG. 3. The federation management service may support various data source federation techniques as described herein, such as federated API generation, subgraph generation, subgraph deployment, subgraph versioning, etc.

As illustrated in FIG. 4, the federation management service 400 may support a user interface 420 that is used to configure a subgraph of a federated API. In some examples, the federation management service 400 supports the user interface 420 that is used to configure and support generation of the federated API based on various data sources (e.g., data sources 215 of FIG. 2). For example, a user may select, using the user interface 420, one or more data sources that are used to generate the federated API. As described herein, the data sources may include tags that correspond to elements of the data sources. In some examples, the federation management service 400 may support entering of tags at the user interface 420. More particularly, the user interface 420 may display elements that are identified from the data sources, and the user may enter custom tags or select existing tags to associate with the elements in the federated API. The federated API may be stored by the federation management service 400 in a graph datastore 415.

After generation of the federated API, the federation management service 400 may support configuration of a subgraph of the federated API. For example, the user interface 420 of the federation management service supports configuration of the subgraph. The federation management service 400 may activate, for selection at the user interface (e.g., user interface 420-a), the set of tags (e.g., tag 450) for selection to include (e.g., “Allow”) or exclude (e.g., “Deny”) from the subgraph. These tags may be identified based on processing the data sources, the federated API, or both. As illustrated in user interface 420-a, the user has selected an “Android” tag for inclusion in the subgraph and has selected the “Experimental” and “Development” tags for exclusion from the subgraph. The user may make such selections for generation of a subgraph that is to be specifically accessed by an application that is executable on an Android device.

After selection of the tags, the user interface 420-b shows a summary 425 of the subgraph (e.g., “view”) and the federated API (e.g., “parent”). The summary 425 shows the quantity of elements (e.g., types, fields, operations) included in the subgraph and the federated API based on the tag selection. Additionally, at user interface 420-b, the user may select a deployment type, a number of worker nodes (e.g., at user interface field 430), and a host environment (e.g., a user interface field 435).

The subgraph may be generated based on the tag selections at the user interface 420-a and the configuration selections at user interface 420-b. The selections may define the metadata for the subgraph. The metadata may be stored in a subgraph metadata datastore 410. Metadata 440 of subgraph metadata datastore 410 illustrates example metadata for the selections at user interface 420-a. As described herein, when generating the subgraph, the metadata for the subgraph and the federated API (e.g., stored in graph datastore 415) may be processed to generate the subgraph, which may be deployed to a host environment based on configuration selections.

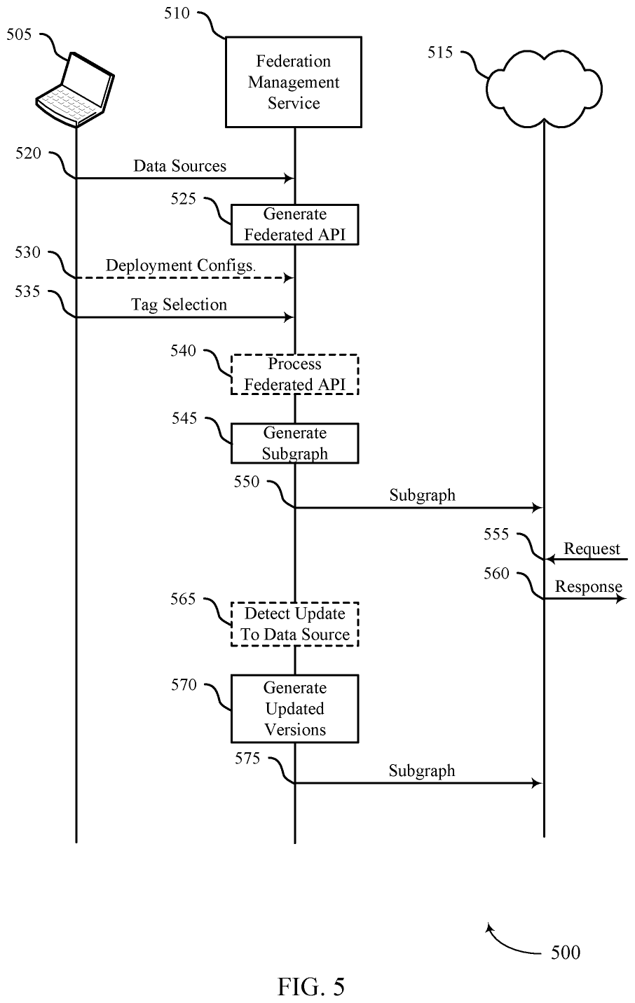

FIG. 5 illustrates an example of a process flow 500 that supports subgraph generation via tagging for a federated application programming interface service in accordance with aspects of the present disclosure. The process flow 500 may be implemented by aspects of system 100 of FIG. 1, computing environment 200 of FIG. 2, federation management service 300 of FIG. 3, or federation management service 400 of FIG. 4. The process flow 500 includes a client device 505, a federation management service 510, and a cloud host 515, which may be examples of the corresponding devices or systems as described with respect to FIGS. 1 through 4. The federation management service 510 may be implemented by one or more servers, as described with respect to FIGS. 2 through 4. In some examples, some signaling or procedure of the process flow 500 may occur in different orders than shown. Additionally, or alternatively, some additional procedures of signaling may occur, or some signaling or procedures may not occur.

At 520, the federation management service 510, may receive, via a user interface, a first user input indicating a plurality of data sources comprising one or more tags corresponding to one or more elements of the plurality of data sources. A user may select the plurality of data sources from a set of available data sources supported by or accessible by the federation management service 510. The tags may be declarative statements included in the specification (e.g., API specification, schema of a database) of the data sources. The tags may be included with element definitions, such as definitions of fields, definitions of operations or methods, or definitions of objects.

At 525, the federation management service 510 may generate a federated API using the plurality of data sources via the federation management service. The federated API includes elements of the plurality of data sources. In some examples, the federation API may include all elements of the plurality of data sources, such as all fields, methods, objects, operations, tables, etc. of the plurality of data sources. In some examples, the federated API may be generated according to configuration parameters input at or selected at the user interface of the federation management service. As described with respect to FIG. 3, a user may add tags to elements or edit tags associated with elements of the underlying data sources using the federation management service 510. That is, the federation management service 510 may receive an input indicating an additional tag that is to be associated with an element of the federated API.

At 530, the federation management service 510 may receive, at the user interface, inputs indicating one or more deployment configurations for a subgraph to be generated based on the API management service. The inputs may define a host for the subgraph (e.g., a host environment) and a quantity of worker nodes (e.g., worker computing environments, replicas) to be associated with a subgraph, among other configurations.

At 535, the federation management service 510 may receive, at the user interface, user input selecting a set of tags of the one or more tags for inclusion or exclusion of corresponding elements in a subgraph of the federated API. For example, tags of the federated API or the data source may be processed by the federation management service 510 and activated and displayed for selection by a user. The user interface may include one or more fields for inputting (e.g., clicking, drag and drop, typing) the tags for inclusion and/or exclusion from the subgraph.

At 540, the federation management service 510 may process the federated API. Processing the federated API may include processing elements corresponding to selected tags. For example, the federation management service 510 may determine that a first element of the federated API is dependent on a second element of the API that is associated with a first tag that is not selected for inclusion in the subgraph. The second element may be a field or object that is to be an input into the first element (e.g., an operation or method). For example, if the second element is tagged as experimental or development, the operation takes the second element as input, and the experimental or development tag is not selected for inclusion in the subgraph, then the operation may be automatically excluded from the subgraph (e.g., the operation is not exposed via a subgraph endpoint). As another example, the first element is a GraphQL operation or an HTTP REST method, and the second element is a request or response object that the GraphQL operation or HTTP method receives as input.

At 545, the federation management service 510 may generate the subgraph for the federated API based at least in part on the user input selecting the set of tags. The subgraph may include a subset of the elements of the plurality of data sources. The subset of elements may include elements that are associated with tags that were selected for inclusion on the subgraph. Generation of the subgraph may include parsing the federated API and creation of an API specification for the subgraph. In some examples, the inputs defining the deployment configurations at 530 and/or the inputs for the tag selections at 535 (e.g., allow: tag[ ] and deny: tag[ ]). may define metadata for the subgraph. The federation management service 510 may use the metadata for the subgraph to process/parse the federated API to generate (e.g., compute) the subgraph.

At 550, the federation management service 510 may deploy the subgraph to a host environment, such as cloud host 515. The subgraph may be deployed according to the selected or input deployment configurations. In some examples, deployment may include instantiating a quantity of worker nodes for handling requests.

At 555 the deployed subgraph may receive an API request, and at 560, the subgraph may transmit a response to the request. The request may be received from a client application that is configured to access the subgraph.

At 565, the federation management service may detect an update to the one or more of the plurality of data sources. The update may include addition of elements, addition or modification of tags corresponding to elements, etc. At 570, the federation management service 510 may generate an update to the federated API based on the update to the one or more of the plurality of data sources, and the federation management service 510 may generate a second version of the subgraph of the federated API based at least in part on the update the federated API. Generation of the second version of the subgraph may include generating the subgraph based on the tags that were modified or added such that the subset of elements included in the subgraph change. Updating the subgraph and/or the federated API may include automatically incrementing the version number corresponding to the subgraph and/or the federated API. At 575, the second version of the subgraph may be deployed to the host environment (e.g., the cloud host 515) for receiving requests and transmitting responses.

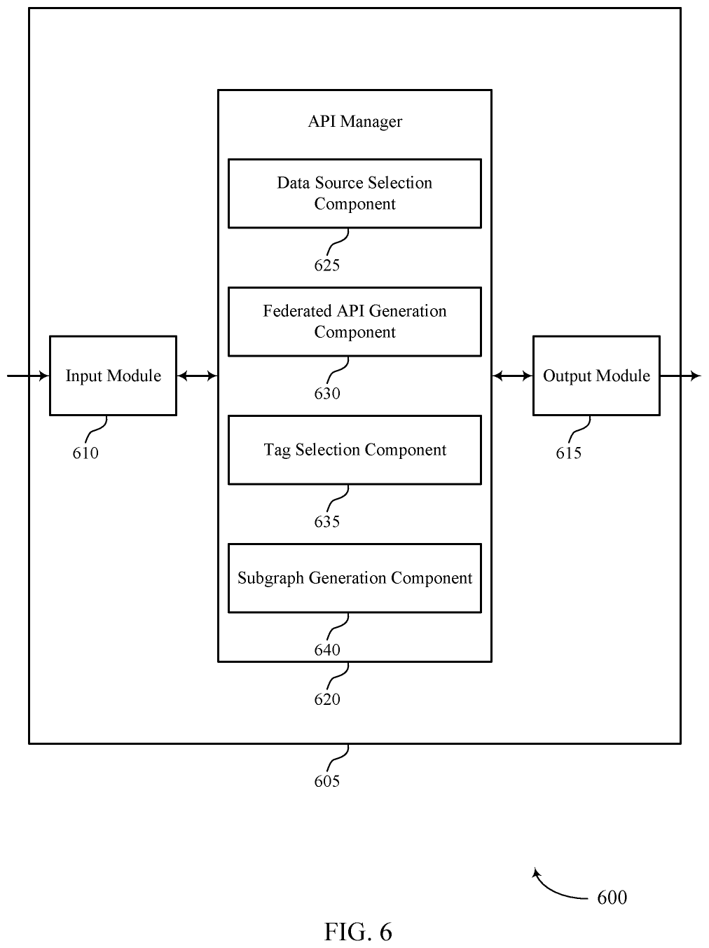

FIG. 6 shows a block diagram 600 of a device 605 that supports subgraph generation via tagging for a federated application programming interface service in accordance with aspects of the present disclosure. The device 605 may include an input module 610, an output module 615, and an API manager 620. The device 605 may also include a processor. Each of these components may be in communication with one another (e.g., via one or more buses).

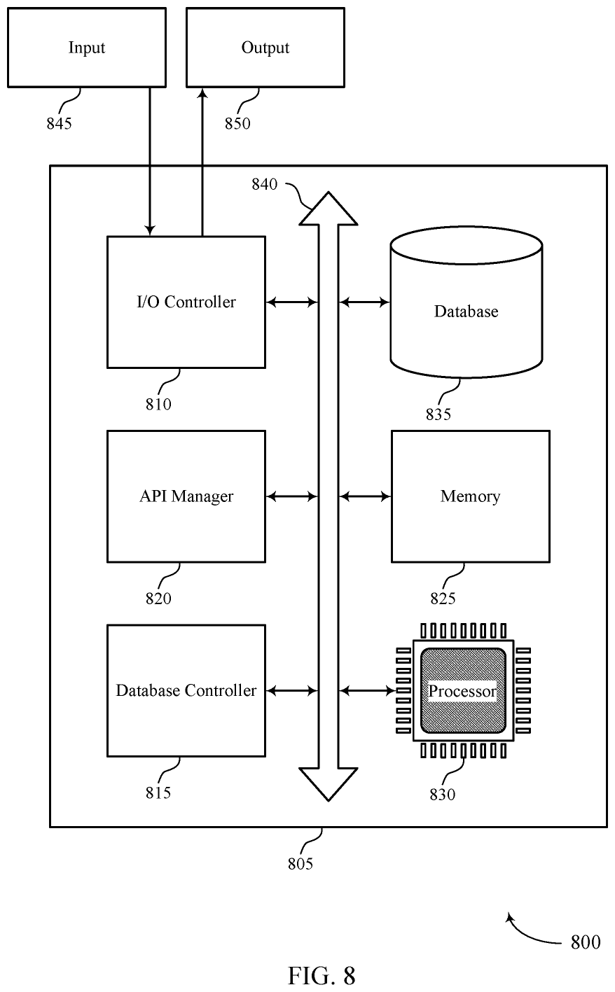

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the API manager 620 to support subgraph generation via tagging for a federated application programming interface service. In some cases, the input module 610 may be a component of an I/O controller 810 as described with reference to FIG. 8.

The output module 615 may manage output signals for the device 605. For example, the output module 615 may receive signals from other components of the device 605, such as the API manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the API manager 620 may include a data source selection component 625, a federated API generation component 630, a tag selection component 635, a subgraph generation component 640, or any combination thereof. In some examples, the API manager 620, or various components thereof, may be configured to perform various operations (e.g., receiving, monitoring, transmitting) using or otherwise in cooperation with the input module 610, the output module 615, or both. For example, the API manager 620 may receive information from the input module 610, send information to the output module 615, or be integrated in combination with the input module 610, the output module 615, or both to receive information, transmit information, or perform various other operations as described herein.

The API manager 620 may support data processing in accordance with examples as disclosed herein. The data source selection component 625 may be configured as or otherwise support a means for receiving, via a user interface of a federation management service, a first user input indicating a set of multiple data sources including one or more tags corresponding to one or more elements of the set of multiple data sources. The federated API generation component 630 may be configured as or otherwise support a means for generating a federated API using the set of multiple data sources via the federation management service, where the federated API includes elements of the set of multiple data sources. The tag selection component 635 may be configured as or otherwise support a means for receiving, via the user interface of the federation management service, a second user input selecting a set of tags of the one or more tags for inclusion or exclusion of corresponding elements in a subgraph of the federated API. The subgraph generation component 640 may be configured as or otherwise support a means for generating the subgraph of the federated API based on the second user input, where the subgraph includes a subset of the one or more elements of the set of multiple data sources.

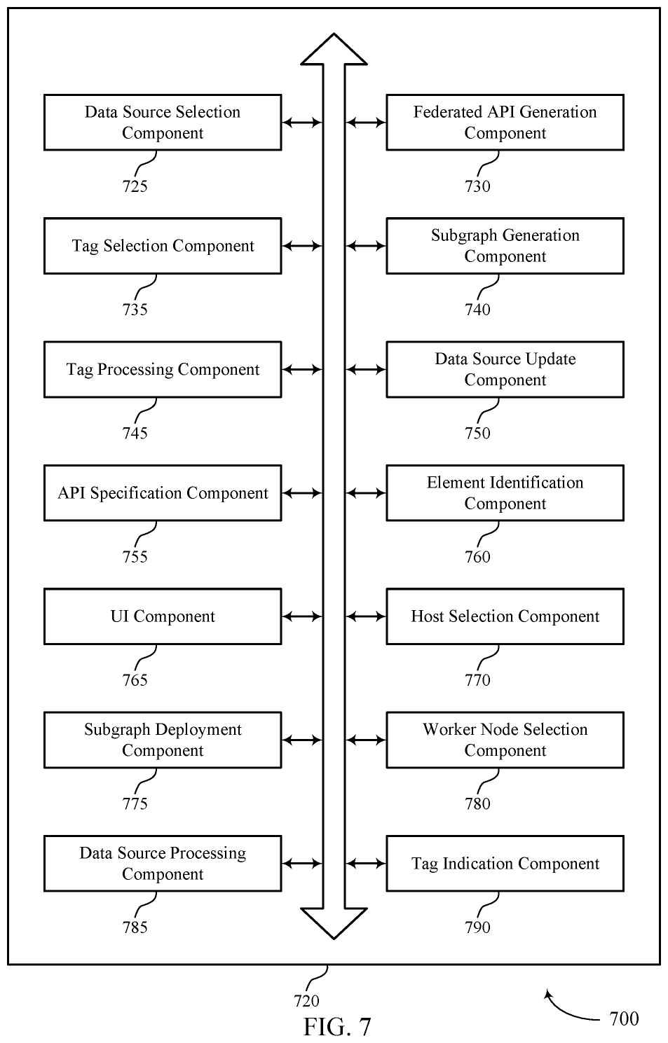

FIG. 7 shows a block diagram 700 of a API manager 720 that supports subgraph generation via tagging for a federated application programming interface service in accordance with aspects of the present disclosure. The API manager 720 may be an example of aspects of an API manager 620, as described herein. The API manager 720, or various components thereof, may be an example of means for performing various aspects of subgraph generation via tagging for a federated application programming interface service as described herein. For example, the API manager 720 may include a data source selection component 725, a federated API generation component 730, a tag selection component 735, a subgraph generation component 740, a tag processing component 745, a data source update component 750, an API specification component 755, an element identification component 760, a UI component 765, a host selection component 770, a subgraph deployment component 775, a worker node selection component 780, a data source processing component 785, a tag indication component 790, or any combination thereof. Each of these components may communicate, directly or indirectly, with one another (e.g., via one or more buses).

The API manager 720 may support data processing in accordance with examples as disclosed herein. The data source selection component 725 may be configured as or otherwise support a means for receiving, via a user interface of a federation management service, a first user input indicating a set of multiple data sources including one or more tags corresponding to one or more elements of the set of multiple data sources. The federated API generation component 730 may be configured as or otherwise support a means for generating a federated API using the set of multiple data sources via the federation management service, where the federated API includes elements of the set of multiple data sources. The tag selection component 735 may be configured as or otherwise support a means for receiving, via the user interface of the federation management service, a second user input selecting a set of tags of the one or more tags for inclusion or exclusion of corresponding elements in a subgraph of the federated API. The subgraph generation component 740 may be configured as or otherwise support a means for generating the subgraph of the federated API based on the second user input, where the subgraph includes a subset of the one or more elements of the set of multiple data sources.

In some examples, to support generating the subgraph, the tag processing component 745 may be configured as or otherwise support a means for determining that a first element of the federated API is dependent on a second element of the federated API that is associated with a first tag that is not selected for inclusion in the subgraph, where the first element is an operation. In some examples, to support generating the subgraph, the subgraph generation component 740 may be configured as or otherwise support a means for generating the subgraph that excludes the first element based on determining that that first element is dependent on the second element associated with the first tag.

In some examples, the data source update component 750 may be configured as or otherwise support a means for detecting an update to the one or more of the set of multiple data sources. In some examples, the federated API generation component 730 may be configured as or otherwise support a means for generating an update to the federated API based on the update to the one or more of the set of multiple data sources and. In some examples, the subgraph generation component 740 may be configured as or otherwise support a means for generating a second version of the subgraph of the federated API based on the update to the federated API.

In some examples, to support generating the subgraph, the API specification component 755 may be configured as or otherwise support a means for generating an API specification for the subgraph that exposes a first element corresponding to a first tag of the set of tags that is selected for inclusion in the subgraph.

In some examples, a second element corresponding to a tag of the set of tags that is selected for exclusion in the subgraph is not exposed via the API specification for the subgraph but is exposed in the federated API.

In some examples, the element identification component 760 may be configured as or otherwise support a means for determining, in response to receiving the second user input, a first quantity of elements that are included in the federated API and a second quantity of elements that are included in the subgraph, where the first quantity of elements is based on the set of multiple data sources and the second quantity of elements is based on the second user input. In some examples, the UI component 765 may be configured as or otherwise support a means for displaying at the user interface, an indication of the first quantity and the second quantity.

In some examples, the host selection component 770 may be configured as or otherwise support a means for receiving, via the user interface of the federation management service, a third user input indicating a host environment for hosting the subgraph of the federated API. In some examples, the subgraph deployment component 775 may be configured as or otherwise support a means for deploying the subgraph of the federated API to the indicated host environment.

In some examples, the worker node selection component 780 may be configured as or otherwise support a means for receiving, via the user interface of the federation management service, a third user input indicating a quantity of worker nodes for the subgraph. In some examples, the subgraph deployment component 775 may be configured as or otherwise support a means for deploying the quantity of worker nodes for hosting the subgraph in a host environment.

In some examples, the data source processing component 785 may be configured as or otherwise support a means for identifying, in response to receiving the first user input, the one or more tags and corresponding elements that are included in a set of multiple API specifications of the set of multiple data sources.

In some examples, the tag selection component 735 may be configured as or otherwise support a means for activating, for selection at the user interface in response to receiving the first user input, the one or more tags, where the second user input is received in response to activating the one or more tags at the user interface.

In some examples, the API specification component 755 may be configured as or otherwise support a means for storing an API specification for the subgraph in a datastore associated with the federation management service.

In some examples, the one or more elements include an operation, a field, an object, or a combination thereof.

In some examples, the tag indication component 790 may be configured as or otherwise support a means for receiving, at the federation management service, a third user input indicating an additional tag that is to be associated with an element of the federated API, where the subgraph of the federated API is generated based on whether the additional tag is selected for inclusion or exclusion of the element into the subgraph.

FIG. 8 shows a diagram of a system 800 including a device 805 that supports subgraph generation via tagging for a federated application programming interface service in accordance with aspects of the present disclosure. The device 805 may be an example of or include the components of a device 605 as described herein. The device 805 may include components for bi-directional data communications including components for transmitting and receiving communications, such as an API manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a basic input/output system (BIOS) which may control basic hardware or software operation such as the interaction with peripheral components or devices.

The processor 830 may include an intelligent hardware device, (e.g., a general-purpose processor, a digital signal processor (DSP), a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting subgraph generation via tagging for a federated application programming interface service).

The API manager 820 may support data processing in accordance with examples as disclosed herein. For example, the API manager 820 may be configured as or otherwise support a means for receiving, via a user interface of a federation management service, a first user input indicating a set of multiple data sources including one or more tags corresponding to one or more elements of the set of multiple data sources. The API manager 820 may be configured as or otherwise support a means for generating a federated API using the set of multiple data sources via the federation management service, where the federated API includes elements of the set of multiple data sources. The API manager 820 may be configured as or otherwise support a means for receiving, via the user interface of the federation management service, a second user input selecting a set of tags of the one or more tags for inclusion or exclusion of corresponding elements in a subgraph of the federated API. The API manager 820 may be configured as or otherwise support a means for generating the subgraph of the federated API based on the second user input, where the subgraph includes a subset of the one or more elements of the set of multiple data sources.

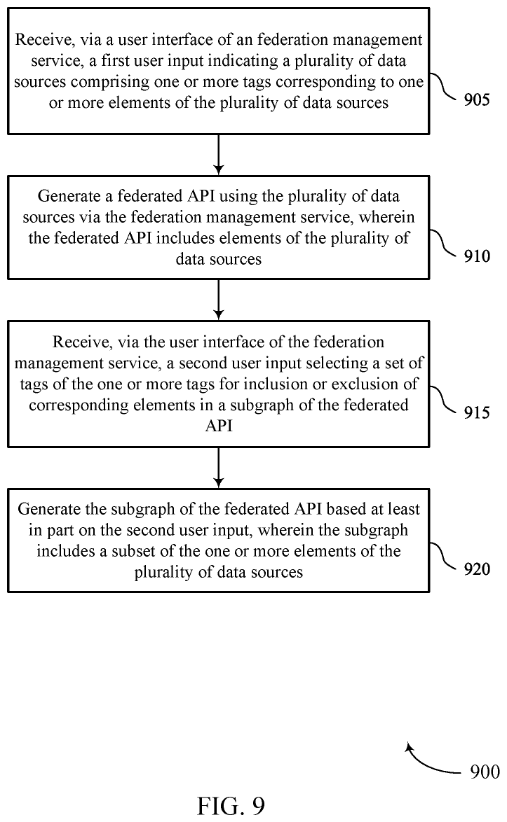

FIG. 9 shows a flowchart illustrating a method 900 that supports subgraph generation via tagging for a federated application programming interface service in accordance with aspects of the present disclosure. The operations of the method 900 may be implemented by a server or its components as described herein. For example, the operations of the method 900 may be performed by a server as described with reference to FIGS. 1 through 8. In some examples, a server may execute a set of instructions to control the functional elements of the server to perform the described functions. Additionally, or alternatively, the server may perform aspects of the described functions using special-purpose hardware.

At 905, the method may include receiving, via a user interface of a federation management service, a first user input indicating a set of multiple data sources including one or more tags corresponding to one or more elements of the set of multiple data sources. The operations of 905 may be performed in accordance with examples as disclosed herein. In some examples, aspects of the operations of 905 may be performed by a data source selection component 725 as described with reference to FIG. 7.

At 910, the method may include generating a federated API using the set of multiple data sources via the federation management service, where the federated API includes elements of the set of multiple data sources. The operations of 910 may be performed in accordance with examples as disclosed herein. In some examples, aspects of the operations of 910 may be performed by a federated API generation component 730 as described with reference to FIG. 7.

At 915, the method may include receiving, via the user interface of the federation management service, a second user input selecting a set of tags of the one or more tags for inclusion or exclusion of corresponding elements in a subgraph of the federated API. The operations of 915 may be performed in accordance with examples as disclosed herein. In some examples, aspects of the operations of 915 may be performed by a tag selection component 735 as described with reference to FIG. 7.

At 920, the method may include generating the subgraph of the federated API based on the second user input, where the subgraph includes a subset of the one or more elements of the set of multiple data sources. The operations of 920 may be performed in accordance with examples as disclosed herein. In some examples, aspects of the operations of 920 may be performed by a subgraph generation component 740 as described with reference to FIG. 7.

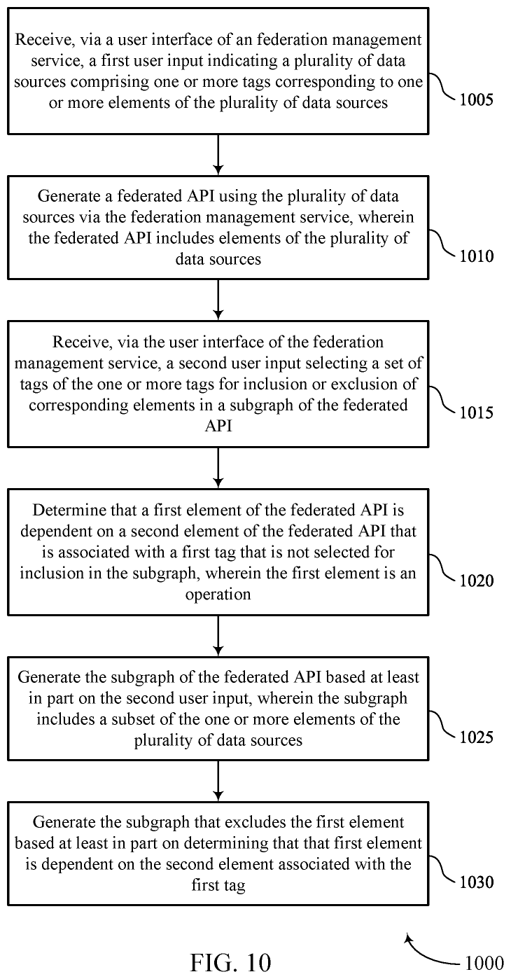

FIG. 10 shows a flowchart illustrating a method 1000 that supports subgraph generation via tagging for a federated application programming interface service in accordance with aspects of the present disclosure. The operations of the method 1000 may be implemented by a server or its components as described herein. For example, the operations of the method 1000 may be performed by a server as described with reference to FIGS. 1 through 8. In some examples, a server may execute a set of instructions to control the functional elements of the server to perform the described functions. Additionally, or alternatively, the server may perform aspects of the described functions using special-purpose hardware.

At 1005, the method may include receiving, via a user interface of a federation management service, a first user input indicating a set of multiple data sources including one or more tags corresponding to one or more elements of the set of multiple data sources. The operations of 1005 may be performed in accordance with examples as disclosed herein. In some examples, aspects of the operations of 1005 may be performed by a data source selection component 725 as described with reference to FIG. 7.

At 1010, the method may include generating a federated API using the set of multiple data sources via the federation management service, where the federated API includes elements of the set of multiple data sources. The operations of 1010 may be performed in accordance with examples as disclosed herein. In some examples, aspects of the operations of 1010 may be performed by a federated API generation component 730 as described with reference to FIG. 7.

At 1015, the method may include receiving, via the user interface of the federation management service, a second user input selecting a set of tags of the one or more tags for inclusion or exclusion of corresponding elements in a subgraph of the federated API. The operations of 1015 may be performed in accordance with examples as disclosed herein. In some examples, aspects of the operations of 1015 may be performed by a tag selection component 735 as described with reference to FIG. 7.

At 1020, the method may include determining that a first element of the federated API is dependent on a second element of the federated API that is associated with a first tag that is not selected for inclusion in the subgraph, where the first element is an operation. The operations of 1020 may be performed in accordance with examples as disclosed herein. In some examples, aspects of the operations of 1020 may be performed by a tag processing component 745 as described with reference to FIG. 7.

At 1025, the method may include generating the subgraph of the federated API based on the second user input, where the subgraph includes a subset of the one or more elements of the set of multiple data sources. The operations of 1025 may be performed in accordance with examples as disclosed herein. In some examples, aspects of the operations of 1025 may be performed by a subgraph generation component 740 as described with reference to FIG. 7.

At 1030, the method may include generating the subgraph that excludes the first element based on determining that that first element is dependent on the second element associated with the first tag. The operations of 1030 may be performed in accordance with examples as disclosed herein. In some examples, aspects of the operations of 1030 may be performed by a subgraph generation component 740 as described with reference to FIG. 7.

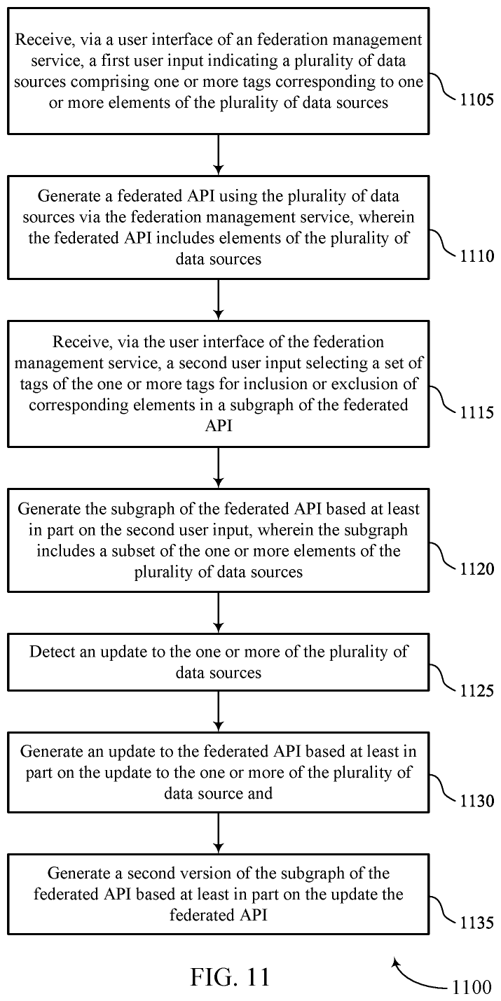

FIG. 11 shows a flowchart illustrating a method 1100 that supports subgraph generation via tagging for a federated application programming interface service in accordance with aspects of the present disclosure. The operations of the method 1100 may be implemented by a server or its components as described herein. For example, the operations of the method 1100 may be performed by a server as described with reference to FIGS. 1 through 8. In some examples, a server may execute a set of instructions to control the functional elements of the server to perform the described functions. Additionally, or alternatively, the server may perform aspects of the described functions using special-purpose hardware.

At 1105, the method may include receiving, via a user interface of a federation management service, a first user input indicating a set of multiple data sources including one or more tags corresponding to one or more elements of the set of multiple data sources. The operations of 1105 may be performed in accordance with examples as disclosed herein. In some examples, aspects of the operations of 1105 may be performed by a data source selection component 725 as described with reference to FIG. 7.

At 1110, the method may include generating a federated API using the set of multiple data sources via the federation management service, where the federated API includes elements of the set of multiple data sources. The operations of 1110 may be performed in accordance with examples as disclosed herein. In some examples, aspects of the operations of 1110 may be performed by a federated API generation component 730 as described with reference to FIG. 7.

At 1115, the method may include receiving, via the user interface of the federation management service, a second user input selecting a set of tags of the one or more tags for inclusion or exclusion of corresponding elements in a subgraph of the federated API. The operations of 1115 may be performed in accordance with examples as disclosed herein. In some examples, aspects of the operations of 1115 may be performed by a tag selection component 735 as described with reference to FIG. 7.

At 1120, the method may include generating the subgraph of the federated API based on the second user input, where the subgraph includes a subset of the one or more elements of the set of multiple data sources. The operations of 1120 may be performed in accordance with examples as disclosed herein. In some examples, aspects of the operations of 1120 may be performed by a subgraph generation component 740 as described with reference to FIG. 7.

At 1125, the method may include detecting an update to the one or more of the set of multiple data sources. The operations of 1125 may be performed in accordance with examples as disclosed herein. In some examples, aspects of the operations of 1125 may be performed by a data source update component 750 as described with reference to FIG. 7.

At 1130, the method may include generating an update to the federated API based on the update to the one or more of the set of multiple data sources and. The operations of 1130 may be performed in accordance with examples as disclosed herein. In some examples, aspects of the operations of 1130 may be performed by a federated API generation component 730 as described with reference to FIG. 7.

At 1135, the method may include generating a second version of the subgraph of the federated API based on the update to the federated API. The operations of 1135 may be performed in accordance with examples as disclosed herein. In some examples, aspects of the operations of 1135 may be performed by a subgraph generation component 740 as described with reference to FIG. 7.

A method for data processing is described. The method may include receiving, via a user interface of a federation management service, a first user input indicating a set of multiple data sources including one or more tags corresponding to one or more elements of the set of multiple data sources, generating a federated API using the set of multiple data sources via the federation management service, where the federated API includes elements of the set of multiple data sources, receiving, via the user interface of the federation management service, a second user input selecting a set of tags of the one or more tags for inclusion or exclusion of corresponding elements in a subgraph of the federated API, and generating the subgraph of the federated API based on the second user input, where the subgraph includes a subset of the one or more elements of the set of multiple data sources.

An apparatus for data processing is described. The apparatus may include a processor, memory coupled with the processor, and instructions stored in the memory. The instructions may be executable by the processor to cause the apparatus to receive, via a user interface of a federation management service, a first user input indicating a set of multiple data sources including one or more tags corresponding to one or more elements of the set of multiple data sources, generate a federated API using the set of multiple data sources via the federation management service, where the federated API includes elements of the set of multiple data sources, receive, via the user interface of the federation management service, a second user input selecting a set of tags of the one or more tags for inclusion or exclusion of corresponding elements in a subgraph of the federated API, and generate the subgraph of the federated API based on the second user input, where the subgraph includes a subset of the one or more elements of the set of multiple data sources.

Another apparatus for data processing is described. The apparatus may include means for receiving, via a user interface of a federation management service, a first user input indicating a set of multiple data sources including one or more tags corresponding to one or more elements of the set of multiple data sources, means for generating a federated API using the set of multiple data sources via the federation management service, where the federated API includes elements of the set of multiple data sources, means for receiving, via the user interface of the federation management service, a second user input selecting a set of tags of the one or more tags for inclusion or exclusion of corresponding elements in a subgraph of the federated API, and means for generating the subgraph of the federated API based on the second user input, where the subgraph includes a subset of the one or more elements of the set of multiple data sources.

A non-transitory computer-readable medium storing code for data processing is described. The code may include instructions executable by a processor to receive, via a user interface of a federation management service, a first user input indicating a set of multiple data sources including one or more tags corresponding to one or more elements of the set of multiple data sources, generate a federated API using the set of multiple data sources via the federation management service, where the federated API includes elements of the set of multiple data sources, receive, via the user interface of the federation management service, a second user input selecting a set of tags of the one or more tags for inclusion or exclusion of corresponding elements in a subgraph of the federated API, and generate the subgraph of the federated API based on the second user input, where the subgraph includes a subset of the one or more elements of the set of multiple data sources.

In some examples of the method, apparatuses, and non-transitory computer-readable medium described herein, generating the subgraph may include operations, features, means, or instructions for determining that a first element of the federated API may be dependent on a second element of the federated API that may be associated with a first tag that may be not selected for inclusion in the subgraph, where the first element may be an operation and generating the subgraph that excludes the first element based on determining that that first element may be dependent on the second element associated with the first tag.

Some examples of the method, apparatuses, and non-transitory computer-readable medium described herein may further include operations, features, means, or instructions for detecting an update to the one or more of the set of multiple data sources, generating an update to the federated API based on the update to the one or more of the set of multiple data source and, and generating a second version of the subgraph of the federated API based on the update the federated API.

In some examples of the method, apparatuses, and non-transitory computer-readable medium described herein, generating the subgraph may include operations, features, means, or instructions for generating an API specification for the subgraph that exposes a first element corresponding to a first tag of the set of tags that may be selected for inclusion in the subgraph.

In some examples of the method, apparatuses, and non-transitory computer-readable medium described herein, a second element corresponding to a tag of the set of tags that may be selected for exclusion in the subgraph may be not exposed via the API specification for the subgraph but may be exposed in the federated API.

Some examples of the method, apparatuses, and non-transitory computer-readable medium described herein may further include operations, features, means, or instructions for determining, in response to receiving the second user input, a first quantity of elements that may be included in the federated API and a second quantity of elements that may be included in the subgraph, where the first quantity of elements may be based on the set of multiple data sources and the second quantity of elements may be based on the second user input and displaying at the user interface, an indication of the first quantity and the second quantity.

Some examples of the method, apparatuses, and non-transitory computer-readable medium described herein may further include operations, features, means, or instructions for receiving, via the user interface of the federation management service, a third user input indicating a host environment for hosting the subgraph of the federated API and deploying the subgraph of the federated API to the indicated host environment.

Some examples of the method, apparatuses, and non-transitory computer-readable medium described herein may further include operations, features, means, or instructions for receiving, via the user interface of the federation management service, a third user input indicating a quantity of worker nodes for the subgraph and deploying the quantity of worker nodes for hosting the subgraph in a host environment.

Some examples of the method, apparatuses, and non-transitory computer-readable medium described herein may further include operations, features, means, or instructions for identifying, in response to receiving the first user input, the one or more tags and corresponding elements that may be included in a set of multiple API specifications of the set of multiple data sources.

Some examples of the method, apparatuses, and non-transitory computer-readable medium described herein may further include operations, features, means, or instructions for activating, for selection at the user interface in response to receiving the first user input, the one or more tags, where the second user input may be received in response to activating the one or more tags at the user interface.

Some examples of the method, apparatuses, and non-transitory computer-readable medium described herein may further include operations, features, means, or instructions for storing an API specification for the subgraph in a datastore associated with the federation management service.

In some examples of the method, apparatuses, and non-transitory computer-readable medium described herein, the one or more elements include an operation, a field, an object, or a combination thereof.

Some examples of the method, apparatuses, and non-transitory computer-readable medium described herein may further include operations, features, means, or instructions for receiving, at the federation management service, a third user input indicating an additional tag that is associated with an element of the federated API, where the subgraph of the federated API may be generated based on whether the additional tag may be selected for inclusion or exclusion of the element into the subgraph.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, via a user interface of a federation management service, a first user input indicating a plurality of data sources comprising one or more tags corresponding to one or more elements of the plurality of data sources;
generating a federated application programming interface (API) using the plurality of data sources via the federation management service, wherein the federated API includes elements of the plurality of data sources;
receiving, via the user interface of the federation management service, a second user input selecting a set of tags of the one or more tags for inclusion or exclusion of corresponding elements in a subgraph of the federated API; and
generating the subgraph of the federated API based at least in part on the second user input, wherein the subgraph includes a subset of the one or more elements of the plurality of data sources.

2. The method of claim 1, wherein generating the subgraph comprises:
determining that a first element of the federated API is dependent on a second element of the federated API that is associated with a first tag that is not selected for inclusion in the subgraph, wherein the first element is an operation; and
generating the subgraph that excludes the first element based at least in part on determining that that first element is dependent on the second element associated with the first tag.

3. The method of claim 1, further comprising:
detecting an update to one or more of the plurality of data sources;
generating an update to the federated API based at least in part on the update to the one or more of the plurality of data sources; and
generating a second version of the subgraph of the federated API based at least in part on the update to the federated API.

4. The method of claim 1, wherein generating the subgraph comprises:
generating an API specification for the subgraph that exposes a first element corresponding to a first tag of the set of tags that is selected for inclusion in the subgraph.

5. The method of claim 4, wherein a second element corresponding to a tag of the set of tags that is selected for exclusion in the subgraph is not exposed via the API specification for the subgraph but is exposed in the federated API.

6. The method of claim 1, further comprising:
determining, in response to receiving the second user input, a first quantity of elements that are included in the federated API and a second quantity of elements that are included in the subgraph, wherein the first quantity of elements is based at least in part on the plurality of data sources and the second quantity of elements is based at least in part on the second user input; and
displaying at the user interface, an indication of the first quantity and the second quantity.

7. The method of claim 1, further comprising:
receiving, via the user interface of the federation management service, a third user input indicating a host environment for hosting the subgraph of the federated API; and
deploying the subgraph of the federated API to the indicated host environment.

8. The method of claim 1, further comprising:
receiving, via the user interface of the federation management service, a third user input indicating a quantity of worker nodes for the subgraph; and
deploying the quantity of worker nodes for hosting the subgraph in a host environment.

9. The method of claim 1, further comprising:
identifying, in response to receiving the first user input, the one or more tags and corresponding elements that are included in a plurality of API specifications of the plurality of data sources.

10. The method of claim 1, further comprising:
activating, for selection at the user interface in response to receiving the first user input, the one or more tags, wherein the second user input is received in response to activating the one or more tags at the user interface.

11. The method of claim 1, further comprising:
storing an API specification for the subgraph in a datastore associated with the federation management service.

12. The method of claim 1, wherein the one or more elements comprise an operation, a field, an object, or a combination thereof.

13. The method of claim 1, further comprising:
receiving, at the federation management service, a third user input indicating an additional tag that is to be associated with an element of the federated API, wherein the subgraph of the federated API is generated based at least in part on whether the additional tag is selected for inclusion or exclusion of the element into the subgraph.

14. An apparatus for data processing, comprising:
a processor;
memory coupled with the processor; and
instructions stored in the memory and executable by the processor to cause the apparatus to:
receive, via a user interface of a federation management service, a first user input indicating a plurality of data sources comprising one or more tags corresponding to one or more elements of the plurality of data sources;
generate a federated application programming interface (API) using the plurality of data sources via the federation management service, wherein the federated API includes elements of the plurality of data sources;
receive, via the user interface of the federation management service, a second user input selecting a set of tags of the one or more tags for inclusion or exclusion of corresponding elements in a subgraph of the federated API; and
generate the subgraph of the federated API based at least in part on the second user input, wherein the subgraph includes a subset of the one or more elements of the plurality of data sources.

15. The apparatus of claim 14, wherein the instructions to generate the subgraph are executable by the processor to cause the apparatus to:
determine that a first element of the federated API is dependent on a second element of the federated API that is associated with a first tag that is not selected for inclusion in the subgraph, wherein the first element is an operation; and
generate the subgraph that excludes the first element based at least in part on determining that that first element is dependent on the second element associated with the first tag.

16. The apparatus of claim 14, wherein the instructions are further executable by the processor to cause the apparatus to:
detect an update to one or more of the plurality of data sources;
generate an update to the federated API based at least in part on the update to the one or more of the plurality of data sources; and
generate a second version of the subgraph of the federated API based at least in part on the update to the federated API.

17. The apparatus of claim 14, wherein the instructions to generate the subgraph are executable by the processor to cause the apparatus to:
generate an API specification for the subgraph that exposes a first element corresponding to a first tag of the set of tags that is selected for inclusion in the subgraph.

18. A non-transitory computer-readable medium storing code for data processing, the code comprising instructions executable by a processor to:
receive, via a user interface of a federation management service, a first user input indicating a plurality of data sources comprising one or more tags corresponding to one or more elements of the plurality of data sources;
generate a federated application programming interface (API) using the plurality of data sources via the federation management service, wherein the federated API includes elements of the plurality of data sources;
receive, via the user interface of the federation management service, a second user input selecting a set of tags of the one or more tags for inclusion or exclusion of corresponding elements in a subgraph of the federated API; and
generate the subgraph of the federated API based at least in part on the second user input, wherein the subgraph includes a subset of the one or more elements of the plurality of data sources.

19. The non-transitory computer-readable medium of claim 18, wherein the instructions to generate the subgraph are executable by the processor to:
determine that a first element of the federated API is dependent on a second element of the federated API that is associated with a first tag that is not selected for inclusion in the subgraph, wherein the first element is an operation; and
generate the subgraph that excludes the first element based at least in part on determining that that first element is dependent on the second element associated with the first tag.

20. The non-transitory computer-readable medium of claim 18, wherein the instructions are further executable by the processor to:
detect an update to the one or more of the plurality of data sources;
generate an update to the federated API based at least in part on the update to the one or more of the plurality of data sources; and
generate a second version of the subgraph of the federated API based at least in part on the update to the federated API.
